(19) United States
(12) Patent Application Publication
(10) Pub. No.: US 2013/0297788 A1
(43) Pub. Date: Nov. 7, 2013

(54) COMPUTER SYSTEM AND DATA MANAGEMENT METHOD

(71) Applicant: Akihiro Itoh, Kawasaki (JP)

(72) Inventor: Akihiro Itoh, Kawasaki (JP)

(73) Assignee: HITACHI, LTD., Tokyo (JP)

(21) Appl. No.: 13/977,849

(22) PCT Filed: Mar. 30, 2011
(86) PCT No.: PCT/JP2011/057940

§ 371 Date: Jul. 1, 2013

(51) Int. Cl. H04L 12/26

(52) U.S. Cl. CPC H04L 43/0876
USPC 709/224

(57) ABSTRACT

In a computer system, plural computers perform an analysis processing of a data set including plural data configured by a key and a data value. Each of the computers retains division information which manages a division position key indicating a division position of a division area obtained by dividing the data set for every predetermined key range, for every data set, all division position keys included in the division information of each of the data sets are the same. When a new data set is stored in the file system, the computer system determines whether there is a target area which is the division area having a data size larger than a predetermined threshold value, based on a data size of each of the division areas after storing the new data set, and if the target area is present, it divides the target area into plural new division areas.

### BACKGROUND

The present invention relates to a technology that combines data in a computer system which processes a large amount of data.

As a technology relating to the joining processing of a table (table or relation) in a database, a method that combines the tables in parallel using a sort and merge joining technology is known (for example, see Japanese Examined Patent Application Publication No. Hei7 (1995)-111718).

The sort and merge joining technology refers to a method that sorts tables to be joined based on a key value and then reads a column of each of the tables from a head thereof and merges columns having corresponding key values.

Japanese Examined Patent Application Publication No. Hei7 (1995)-111718 discloses that tables are classified in accordance with positions corresponding to the same key value in order to parallelize processings to create a division area corresponding to every table and combine the tables in every division area using the sort and merge joining technology. Further, Japanese Examined Patent Application Publication No. Hei7 (1995)-111718 discloses that in order to prevent the deviation in a process load in the system, the division area is allocated to the process.

As a basic technology regarding a database, a technology that prepares a table (index) which associates a key value with a storage position of data corresponding to the key value and designates the key value when a search processing of data is performed to obtain data at a high speed is known (for example, see Japanese Unexamined Patent Application Publication No. Hei6 (1994)-52231). Japanese Patent Application Laid-Open No. Hei6 (1994)-52231 discloses a matrix index which associates a combination of two or more keys with a storage position of data.

Further, a technology that changes a storage area in which data is stored for every range of the key value so that plural storage areas is available is generally used (for example, see Japanese Unexamined Patent Application Publication No. 2001-142751). Japanese Patent Application Laid-Open No. 2001-142751 discloses a method that, when the storage area is added, equalizes a usage amount of each of the storage area while suppressing an amount of data moving from an existing storage area to a newly added storage area.

### SUMMARY

In a data analysis system, data which is periodically obtained is stored and if necessary, the stored data are joined to perform an analysis processing.

Here, an example of data which is processed by the data analysis system will be described with reference to the drawing.

FIG. 20 is an explanatory diagram illustrating an example of data which is processed in a data analysis system of the related art. FIG. 21 is an explanatory diagram illustrating an example of a schema in data of the related art. FIGS. 22A to 22C are explanatory diagrams illustrating an example of data which is processed in an analysis processing of the related art.

The example illustrated in FIG. 20 represents a movement history of a user. Specifically, the example is data which includes a user ID which identifies the user, positions X and Y which is coordinate information specifying a position of the user, and a time stamp which is a time when the user moves to the corresponding position.

In the analysis processing for data as illustrated in FIG. 20, for example, as illustrated in FIG. 21, data is converted based on a schema. Further, the converted data is grouped for every user ID, as illustrated in FIG. 22A so as to perform an analysis processing such as aggregate calculation.

However, since it takes time to convert data as illustrated in FIG. 20 into data as illustrated in FIG. 22A at the time of performing the analysis processing, in the data analysis system, in order to efficiently perform the analysis processing, data which is converted into data as illustrated in FIG. 22A in advance is stored and the analysis processing is performed using the stored data.

Further, in this specification, data which includes one or more records is referred to as a data set. Further, a data set as illustrated in FIG. 20 is referred to as raw data and data having a structure as illustrated in FIG. 21 is referred to as structured data.

In the storage processing, data with a format illustrated in FIG. 20 is periodically (for example, monthly) is collected and then converted into data having a format of FIG. 22A to be stored in a data analysis system. Therefore, if plural data is aggregated to perform an analysis processing of data for one year or an analysis processing of data for a specific month for every year, plural data having the format illustrated in FIG. 22A needs to be joined.

For example, according to the data analysis system, two data as illustrated in FIGS. 22A and 22B are joined to be data as illustrated in FIG. 22C.

Here, from a fact that column data (record) of the same user ID is merged, a processing which is equivalent to joining in a database needs to be performed. Further, in the above-mentioned example, as data to be joined, not only two data, but also plural tables may be joined.

Further, data which is periodically stored may have different size distribution for every data. For example, in data of a user whose number of times using service for every month is varied, difference in a size distribution of data occurs on every month.

In Japanese Examined Patent Application Publication No. Hei7 (1995)-111718, a method that determines a position (division position) which classifies a table when a table is classified is not disclosed. Generally, in order to equally classify the tables, distribution information of keys which are included in the table is required. When the key distribution information is obtained, if a method that scans entire tables is used, it takes time to complete the processing.

As another method that obtains the key distribution information, there is a method that uses an index disclosed in Japanese Unexamined Patent Application Publication No. Hei6 (1994)-52231. In the index, the table includes all key values so that the key distribution information may be obtained by scanning the index. The index has a smaller data size than the table, and thus a processing time may be reduced.

However, when plural tables are joined, the indexes as many as the number of tables need to be scanned, which increases the processing time. Further, if there is a large quantity of target data, there is a problem in that it takes time to perform a processing of creating an index at the time of creating a table and a processing of updating the index at the time of updating the table.

For this reason, it is considered to use a method disclosed in Japanese Unexamined Patent Application Publication No. 2001-142751, instead of using the index. That is, a method that manages tables which are divided into plural division areas in advance, matches the division areas of each of the tables with each other and performs a merge joining processing in parallel for every division area is considered.

However, generally, the division position of the table is different in every table so that it is difficult to match the division areas. Even though division positions of all tables match, there is another problem in that a deviation in a data size may occur in each division area at the time of updating the data.

In other words, since the data size distribution is different for every data which is periodically stored, a deviation in the data size in each division area may occur by the combination of the data, in a division position fixed in advance. Therefore, when the joining processing is performed in parallel, a variation in a throughput is caused so that it is difficult to efficiently perform the parallel processing.

A representative example of the present invention disclosed in this application will be described as follows.

That is, in a computer system in which plural computers perform an analysis processing of a data set including plural data configured by a key and a data value, in parallel,
each of the computers includes a processor, a memory connected to the processor, a storage device connected to the processor, and a network interface connected to the processor, and
each of the computers retains division information which manages a division position key which is a key indicating a division position of a division area obtained by dividing the data set for every predetermined key range, for every data set, all division position keys included in the division information of each of the data set are same, a file system that stores the data set is configured on a storage area of each of the plurality of computers, and the computer system, when performing the analysis processing, creates plural tasks for every division area, allocates the created task into each of the computers, and combines the data included in the division areas of each of the data sets to perform the analysis processing, when a new data set is stored in the file system, determines whether there is a target area which is the division area having a data size larger than a predetermined threshold value, based on a data size of each of the division areas after storing the new data set, and if it is determined that there is the target area, divides the target area into plural new division areas.

According to the representative aspect of the present invention, it is possible to perform the joining processing of the data sets in parallel without creating the index. Further, if a new data set is added, it is possible to suppress the variation in an amount of data for every division area so that it is possible to equalize the throughputs between tasks which perform the joining processing.

### BRIEF DESCRIPTION OF THE DRAWINGS

FIG. 1 is a block diagram illustrating a system configuration of a data analysis system according to a first embodiment of the present invention;

FIG. 2 is a block diagram illustrating a hardware configuration of a node according to the first embodiment of the present invention;

FIG. 3A is a block diagram illustrating a software configuration of a master node according to the first embodiment of the present invention;

FIG. 3B is a block diagram illustrating a software configuration of a slave node according to the first embodiment of the present invention;

FIG. 4 is an explanatory diagram illustrating an example of a data management table according to the first embodiment of the present invention;

FIG. 5A is an explanatory diagram illustrating an example of a division table according to the first embodiment of the present invention;

FIG. 5B is an explanatory diagram illustrating an example of a division table according to the first embodiment of the present invention;

FIG. 6 is an explanatory diagram illustrating an example of a partition table according to the first embodiment of the present invention;

FIG. 7A is an explanatory diagram illustrating an example of a key size table according to the first embodiment of the present invention;

FIG. 7B is an explanatory diagram illustrating an example of a key size table according to the first embodiment of the present invention;

FIG. 8 is a flowchart explaining a joining processing and an analysis processing of data according to the first embodiment of the present invention;

FIG. 9 is a flowchart explaining a data addition processing according to the first embodiment of the present invention;

FIG. 10 is a flowchart explaining details of a grouping processing according to the first embodiment of the present invention;

FIG. 11 is a flowchart explaining a data output processing according to the first embodiment of the present invention;

FIG. 12 is a flowchart explaining a data size confirmation processing according to the first embodiment of the present invention;

FIG. 13 is an explanatory diagram illustrating an example of a key size table according to the first embodiment of the present invention;

FIG. 14A is an explanatory diagram illustrating an example of a division table after division according to the first embodiment of the present invention;

FIG. 14B is an explanatory diagram illustrating an example of a division table after division according to the first embodiment of the present invention;

FIG. 15 is an explanatory diagram illustrating an example of a key size table after division according to the first embodiment of the present invention;

FIG. 16 is an explanatory diagram illustrating a schema of a record in a second embodiment of the present invention;

FIG. 17 is an explanatory diagram illustrating an example of a record in the second embodiment of the present invention;

FIG. 18A is an explanatory diagram illustrating a file in the second embodiment of the present invention;

FIG. 18B is an explanatory diagram illustrating a file in the second embodiment of the present invention;

FIG. 18C is an explanatory diagram illustrating a file in the second embodiment of the present invention;

FIG. 19 is an explanatory diagram illustrating an example of a division table in the second embodiment of the present invention;

FIG. 20 is an explanatory diagram illustrating an example of data which is processed in a data analysis system of the related art;

FIG. 21 is an explanatory diagram illustrating an example of a schema in data of the related art;

FIG. 22A is an explanatory diagram illustrating an example of data which is processed in an analysis processing of the related art;

FIG. 22B is an explanatory diagram illustrating an example of data which is processed in an analysis processing of the related art; and

FIG. 22C is an explanatory diagram illustrating an example of data which is processed in an analysis processing of the related art.

### DETAILED DESCRIPTION

### First Embodiment

Hereinafter, a first embodiment of the present invention will be described.

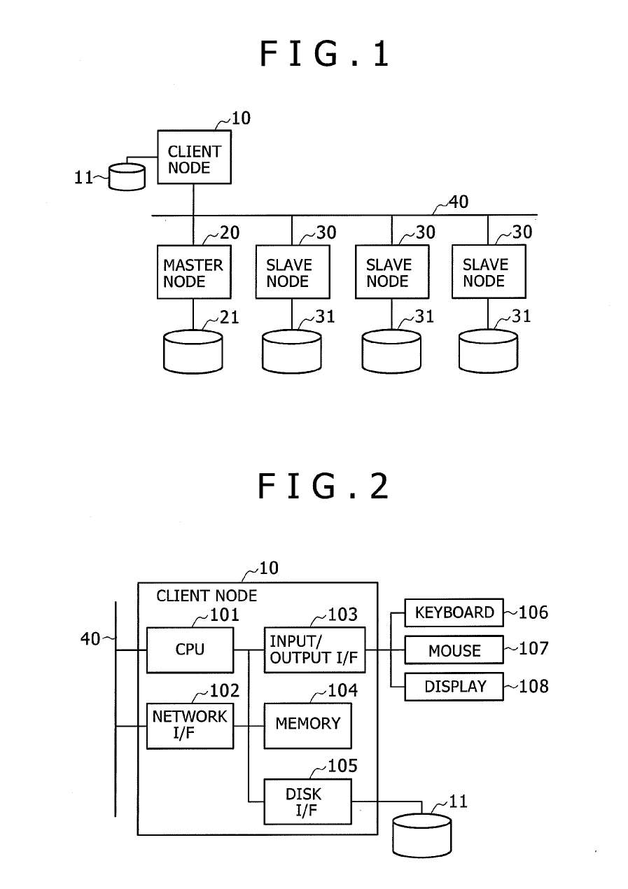

FIG. 1 is a block diagram illustrating a system configuration of a data analysis system according to a first embodiment of the present invention.

The data analysis system includes a client node 10, a master node 20, and a slave node 30 and the nodes are connected to each other through a network 40. Further, even though SAN, LAN, and WAN are considered as the network 40, if it is possible to communicate between nodes, any network may be available. In addition, the nodes may be directly connected.

Here, the node refers to a computer. Hereinafter, the computer is referred to as a node.

The client node 10 is a node which is used by a user of the data analysis system. The user uses the client node 10 to transmit various instructions to the master node 20 and the slave node 30.

The master node 20 is a node which manages the entire data analysis system. The slave node 30 is a node which performs processings (tasks) in accordance with the instruction transmitted from the master node 20. Further, the data analysis system is one of parallel distributed processing systems and improves the processing performance of the system by increasing the number of slave nodes 30.

Further, the client node 10, the master node 20, and the slave node 30 have the same hardware configuration, which will be described in detail with reference to FIG. 2 herein below.

Storage devices 11, 21, and 31 such as an HDD are connected to the respective nodes. In each of the storage devices 11, 21, and 31, a program which implements a function of each of the nodes, such as an OS, is stored. Each of the programs is read out from the storage devices 11, 21, and 31 by a CPU (see FIG. 2) and executed by the CPU (see FIG. 2).

FIG. 2 is a block diagram illustrating a hardware configuration of the node according to the first embodiment of the present invention.

In FIG. 2, even though the client node 10 is illustrated as an example, the master node 20 and the slave node 30 also have the same hardware configuration.

The client node 10 includes a CPU 101, a network I/F 102, an input/output I/F 103, a memory 104, and a disk I/F 105, which are connected to each other through an internal bus.

The CPU 101 executes a program to be stored in the memory 104.

The memory 104 stores a program which is executed by the CPU 101 and information required to execute the program. Further, the program which is stored in the memory 104 may be stored in the storage device 11. In this case, the program is read from the storage device 11 onto the memory 104 by the CPU 101.

The network I/F 102 is an interface for connection with other node through the network 40. The disk I/F 105 is an interface for connection with the storage device 11.

The input/output I/F 103 is an interface to connect input/output devices such as the keyboard 106, the mouse 107, and the display 108. The user transmits an instruction to the data analysis system using the input/output device and confirms an analysis result.

Further, the master node 20 and the slave node 30 may not include the keyboard 106, the mouse 107, and the display 108.

Next, a software configuration of the master node 20 and the slave node 30 will be described.

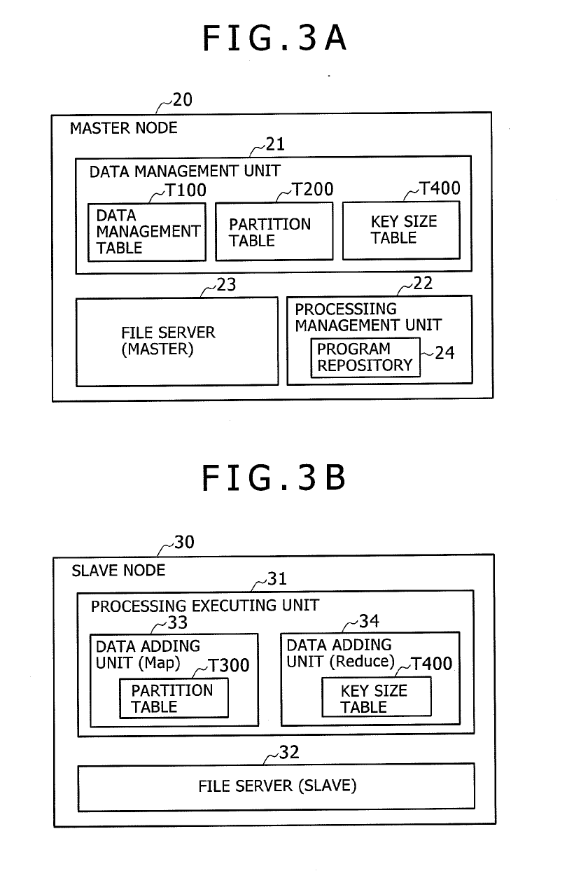

FIG. 3A is a block diagram illustrating the software configuration of the master node 20 according to the first embodiment of the present invention.

The master node 20 includes a data management unit 21, a processing management unit 22, and a file server (master) 23.

The data management unit 21, the processing management unit 22, and the file server (master) 23 are programs which are stored on the memory 104 and executed by the CPU 101. Hereinafter, if the processing is described with the program as a subject, it is considered that the program is executed by the CPU 101.

The data management unit 21 manages data which is processed by the data analysis system. The data management unit 21 includes a data management table T100, a division table T200, and a key size table T400.

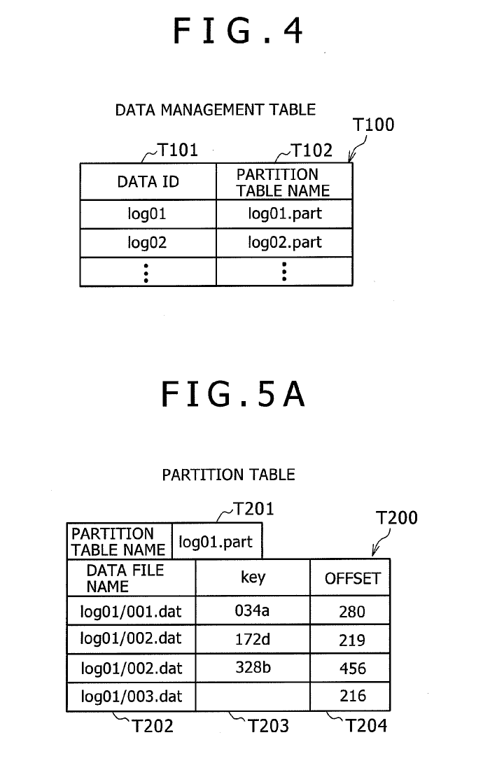

The data management table T100 stores management information of a data set which is processed by the data analysis system. Details of the data management table T100 will be described below with reference to FIG. 4. Here, the data set indicates data which is configured by plural records.

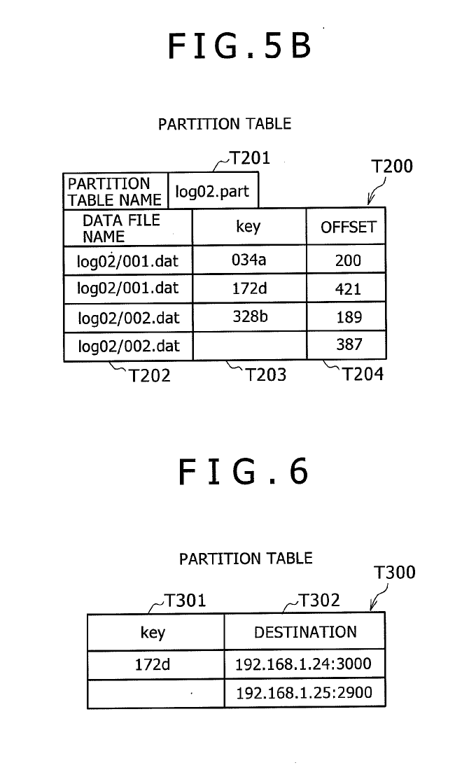

The division table T200 stores management information of a division area obtained by dividing the data set. Here, the division area indicates a record group in which the data set is divided for every predetermined key range. Details of the division table T200 will be described below with reference to FIG. 5.

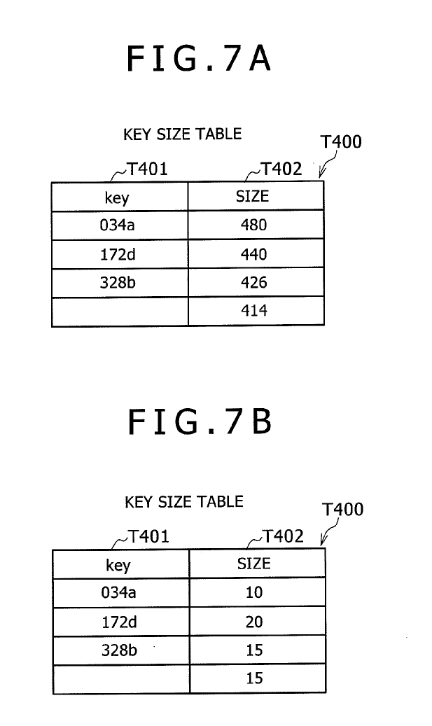

The key size table T400 stores management information of a data size of each of the division areas in the data set. One key size table T400 corresponds to one data set. Further, a key size table T400 which manages a data size of a data set of the entire data analysis system is also included. Details of the key size table T400 will be described below with reference to FIG. 7.

The processing management unit 22 manages a parallel processing which is distributed to be performed on each of the slave nodes 30 The processing management unit 22 includes a program repository 24 which manages a program which creates processings (tasks) performed in parallel. In other words, the processing management unit 22 creates a task which needs to be performed in each of the slave nodes 30 from the program repository 24 and instructs the slave node 30 to execute the created task.

The file server (master) 23 manages a file which stores actual data.

Further, the software configuration of the master node 20 may be implemented by hardware.

FIG. 3B is a block diagram illustrating the software configuration of the slave node 30 according to the first embodiment of the present invention.

The slave node 30 includes a processing executing unit 31 and a file server (slave) 32.

The processing executing unit 31 and the file server (slayer) 32 are programs which are stored on the memory 104 and executed by the CPU 101. Hereinafter, if the processing is described with the program as a subject, it is considered that the program is executed by the CPU 101.

The processing executing unit 31 receives an instruction to execute the processing (task) from the processing management unit 22 of the master node 20 and executes a predetermined processing (task). That is, the processing executing unit 31 creates a process to execute the corresponding processing (task) based on a received instruction to execute the processing (task). As the created process is executed, plural tasks are executed on each of the slave nodes 30 so that a parallel distributed processing is achieved.

The processing executing unit 31 of the present embodiment includes a data adding unit (Map) 33 and a data adding unit (Reduce) 34 which execute the above-mentioned tasks.

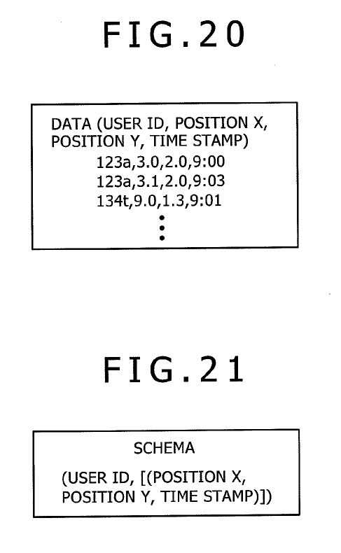

The data adding unit (Map) 33 reads out data in the unit of record from the input raw data (see FIG. 20) and outputs the read raw data to the data adding unit (Reduce) 34 for every key range. Further, in the data adding unit (Reduce) 34, a key range in which the processing is preformed is set in advance.

The data adding unit (Map) 33 includes a partition table T300. The data adding unit (Map) 33 specifies the data adding unit (Reduce) 34 which outputs the read data based on the partition table T300. Further, the partition table T300 will be described below with reference to FIGS. 7A and 7B.

The data adding unit (Reduce) 34 converts the input raw data into a predetermined format, for example, structured data (see FIG. 21) and outputs the structured data to a distributed file system.

The data adding unit (Reduce) 34 includes a key size table T400. The key size table T400 is the same as the key size table T400 which is included in the data management unit 21. However, in the key size table T400, only management information on a division area of a key range which the data adding unit (Reduce) 34 undertakes is stored.

The file server (slave) 32 manages a file which is distributed to be arranged. The file server (master) 23 has a function to manage metadata (a directory structure, a size, or an update date) of a file and to provide one file system in connection with the file server (slave) 32.

The data adding unit (Map) 33 and the data adding unit (Reduce) 34 access to the file server (master) 23 to execute various tasks using the file on the file system. That is, the data adding unit (Map) 33 and the data adding unit (Reduce) 34 may access to the same file system.

Further, the software configuration of the slave node 30 may be implemented by hardware.

Next, details of tables included in the data management unit 21 will be described.

FIG. 4 is an explanatory view illustrating an example of the data management table T100 according to the first embodiment of the present invention.

The data management table T100 includes a data ID T101 and a division table name T102. The data ID T101 stores an identifier of the data set. The division table name T102 stores a name of the division table T200 corresponding to the data set.

Each of entries of the data management table T100 corresponds to one data set which is managed by the data analysis system. Further, the data set corresponds to one table (relation) in a general database.

FIGS. 5A and 5B are explanatory diagrams illustrating an example of the division table T200 according to the first embodiment of the present invention.

FIG. 5A illustrates an example of a division table T200 of a data set whose division table name T102 is “log 01.part”. FIG. 5B illustrates an example of a division table T200 whose division table name T102 is “log 02.part”.

The division table T200 stores management information indicating a division method of each of the data sets which is processed by the data analysis system. The division table T200 includes a division table name T201, a data file name T202, a key T203, and an offset T204.

The division table name T201 stores a name of the division table T200. The division table name T201 is the same as the division table name T102.

In the data file name T202, a name of a file in which data corresponding to the division area is stored is stored.

In the key T203, a key value indicating a key range of the division area, that is, a key value indicating the division position of the data set is stored. In the key T203, a key value indicating an ending point in the division area is stored.

In the offset T204, an offset corresponding to a value of the division position in the data set is stored. In the offset T204, an offset of a key corresponding to the key T203 is stored. Further, if the data file names T202 are different, the files in which data is stored are different, so that an offset of a corresponding entry is counted again from “0”.

A starting position of the division area corresponds to a key T203 and an offset T204 of one entry ahead. A key indicating a starting position of a first division area and a key indicating an ending position of a last division area are not defined so that these keys are not listed in the division table T200.

Each entry of each of the division tables T200 corresponds to one division area which is managed by the data analysis system.

For example, a division table name T101 of the first entry of the data management table T100 illustrated in FIG. 4 is “log 01.part” and corresponds to the division table T200 illustrated in FIG. 5A.

The first entry of the division table T200 illustrated in FIG. 5A corresponds to the first division area. The first entry represents that data of the corresponding division area is stored in a file whose data file name T202 is “log 01/001.dat”.

Further, from a fact that the key T203 of the first entry is “034a”, it is known that a key range of the first division area is below “034a”. Further, from a fact that the offset T204 of the first entry is “280, it is known that the data of the first division area is stored in a range where an offset on the file is “0 to 279”.

Further, a second entry of the division table T200 illustrated in FIG. 5A indicates that the key range of the corresponding division area is “034a” and over and below “172d” and the data file name T202 is “log 01/002.dat”. In addition, the data file name T202 is different from that of the first entry, so that the offset is counted from “0”. Therefore, it is known that data of the division area corresponding to a range where the offset is “0 to 218” is stored.

Further, a third entry of the division table T200 illustrated in FIG. 5A indicates that the key range of the corresponding division area is “172d” and over and below “328b” and the data file name T202 is “log 01/002.dat”. In addition, the data file name T202 matches with that of the second entry, which indicates that the data of the division area corresponding to a range where the offset on the file is “219 to 455” is stored

Further, the division table name T101 of a second entry of the data management table T100 illustrated in FIG. 4 is “log 02.part” and corresponds to the division table T200 illustrated in FIG. 5B.

A data file name T202 and an offset T204 of each of the entries which is stored in the division table T200 illustrated in FIG. 5B are different from those of each of the entries of the division table T200 illustrated in FIG. 5A. However, keys T203 indicating the division positions of both division tables T200 are identical to each other.

In the embodiment, the division positions of the division area in data sets which are likely to be joined, that is, keys T203 are managed to be necessarily identical to each other. By doing this, it is possible to parallelize the joining processing of two or more data sets. In other words, it is possible to associate the keys T203 of the division tables T200 of the data sets to be joined with the same entry and perform the joining processing for every division area in parallel.

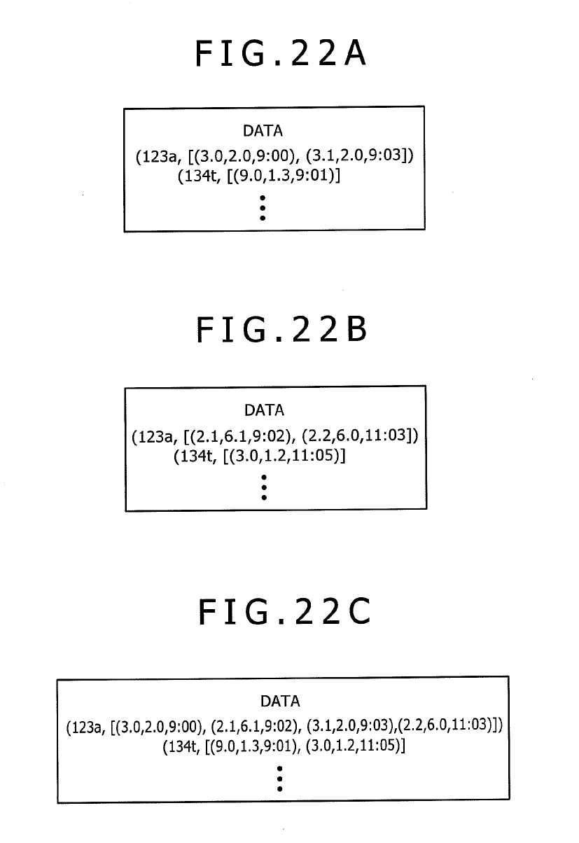

A file includes plural records each of which includes one key and one or more values as illustrated in FIG. 22A. Further, each of the files is stored in a distributed file system to be sorted based on the key. By doing this, when the joining processing is performed for every division area, it is possible to perform the merge joining on the files having the same key.

Further, files in which data in the different division areas is stored may be identical to each other. For example, in FIG. 5A, the second entry and the third entry are the identical file. However, the key ranges of the entries are different.

As described above, in FIG. 5A, the number of files is three, but the number of division areas is four, that is, the number of files is different from the number of division areas. As will be described below, the number of files matches with a parallelism of a data addition processing in the data analysis system. In the meantime, the number of division areas depends on the parallelism of the data analysis processing. Therefore, the number of files and the number of division areas depend on different processings so that both numbers do not have a dependence relationship and may be arbitrarily defined.

FIG. 6 is an explanatory view illustrating an example of the partition table T300 according to the first embodiment of the present invention.

In the partition table T300, a newly added data set (raw data) is divided and information used to allocate corresponding data is stored in the data adding unit (Reduce) 34 which executes the task. The partition table T300 includes a key T301 and a destination T302.

In the key T301, a key value indicating a division position of an input data set is stored. In the destination T302, destination information indicating a position of the data adding unit (Reduce) 34 which undertakes a processing of the divided data set is stored. In an example illustrated in FIG. 6, a node and a corresponding data adding unit (Reduce) 34 are designated by the destination information including an IP address and a port.

FIGS. 7A and 7B are explanatory diagrams illustrating an example of a key size table T400 according to the first embodiment of the present invention.

In the key size table T400, a data size of the division area is stored. The key size table T400 includes a key T401 and a size T402.

The key T401 is identical to the key T203. In the size T402, a data size of the division area having T401 as a division position is stored.

Further, in the size T402, a total value of the data sizes of the division areas which are a target of the joining processing is stored.

The key size table T400 is dynamically created at the time of performing the joining processing, the analysis processing, and the data addition processing, which will be described below.

Next, the joining processing and the analysis processing of data will be described.

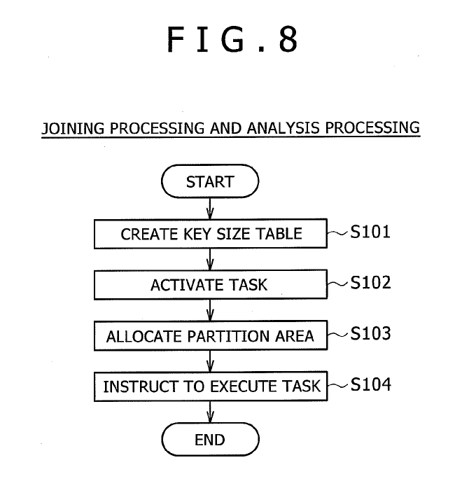

FIG. 8 is a flowchart explaining a joining processing and an analysis processing of data according to the first embodiment of the present invention.

The joining processing is necessarily performed together with the analysis processing. In other words, after joining one record of data by the joining processing, the analysis processing is performed on the data.

The joining processing and the analysis processing are performed by the data management unit 21 which receives an instruction from the user. Further, the instruction from the user includes a data ID of the data set to be joined.

First, the master node 20 creates a key size table T400 corresponding to the data set to be processed (step S101).

Specifically, the following processings will be performed.

The data management unit 21 searches a data management table T100 based on the data ID included in the instruction transmitted from the user and obtains a division table name T102 from the corresponding entry.

Next, the data management unit 21 obtains a division table T200 corresponding to the obtained division table name T102.

The data management unit 21 specifies a key value indicating a division position for every division area and calculates a data size of the data set to be joined, based on the obtained division table T200.

Further, the data management unit 21 creates the key size table T400 based on the above-mentioned processing result.

For example, when data sets whose data IDs (T101) are “log 01” and “log 02” are joined, corresponding division tables T200 are as illustrated in FIGS. 5A and 5B, respectively. In this case, the data management unit 21 performs the above processing to create the key size table T400 as illustrated in FIG. 7A by adding the data sizes of two data sets for every division area.

Next, the master node 20 creates plural tasks each including a set of joining processing and analysis processing and allocates each created task to each of the slave nodes 30 to activate a corresponding task (step S102).

Specifically, the processing management unit 22 reads out a program required for the processing from the program repository 24 and creates tasks as many as a parallel number designated by the user. Further, the processing management unit 22 executes the created task on each of the slave nodes 30.

Further, if the parallel number is smaller than the number of entries of the key size table T400 created in step S101, the number of entries is assumed as a parallel number and the tasks as many as the number of entries are executed on the slave node 30.

Next, the master node 20 allocates the division area to each of the tasks (step S103).

Specifically, the data management unit 21 allocates the division area corresponding to each of the entries of the key size table T400 created in step S101 to each of the tasks which is created in step S102.

Further, the data management unit 21 allocates the division area to each of the tasks so as to equalize the data size, based on the size T402 of the key size table T400.

As the allocation method of the division area described above, for example, a method in which the data management unit 21 sorts the entries of the key size table T400 based on the size T402 and allocates and allocates the entries in the descending order of a data size to the tasks in the ascending order of the allocated data size is considered.

The data management unit 21, after completely allocating the division area, transmits a data file name and an offset position of a file to be joined to the slave node 30 to which the task is allocated.

For example, in the case of a task to which the division area corresponding to the first entry of the key size table T400 of FIG. 7A is allocated, the entry of the corresponding division table T200 is the first entry of each of FIGS. 5A and 5B. Therefore, the data management unit 21 transmits (data file name, starting position, ending position)=(log 01/001.dat, 0, 280), (log 02/001.dat, 0, 200) to a slave node 30 to which the task is allocated.

Next, the master node 20 transmits an instruction to execute the task to the slave node 30 to which the task is allocated and completes the processing (step S104).

Specifically, the data management unit 21 transmits the instruction to execute the task to the slave node 30 to which the task is allocated.

The slave node 30 which receives the instruction from the master node 20 accesses to the file server (master) 23 to read out the designated file from the designated offset position based on the data file name and the offset position received from the data management unit 21.

Each of the slave nodes 30 performs the joining processing so as to be associated with the key of each of the read files. Further, the slave node 30 outputs a result of the joining processing for every record to the analysis processing task while being executed in the same slave node 30.

For example, in the analysis processing for the data set illustrated in FIGS. 5A and 5B, a task is created for every four division areas and the above-mentioned joining processing is performed by the task.

In this case, if the division positions are different in every data set, the processing is performed in an overlapping key range so that the parallel processing may not be achieved. However, in the embodiment, since the division positions of the data sets are same so that the joining processing in the division areas of each of the data sets may be performed in parallel.

The data joining processing and the analysis processing have been described above.

Next, the data addition processing will be described.

The data addition processing is a processing to add a new data set to a data set in which the data management table T100 and the division table T200 are created, that is, when an existing data set is stored in the distributed file system.

Generally, the data sizes of the division areas are different in every data set. Therefore, if the division areas of each of the data sets are joined without correcting the division position, a variation in the data size between the division areas is caused. As a result, a variation in the throughput of the task which performs the analysis processing is caused so that the efficiency of the parallel processing is lowered.

In this invention, in order to solve the above-mentioned problems, processing which will be described below is performed at the time of performing the data addition processing so that the division area is redivided and the data size of each of the division areas is equalized.

Specifically, the division position is controlled so that, when the entire data sets which will be a joining target are joined after adding the new data set, the data size of the division area is equal to or smaller than a predetermined reference value. By doing this, the differences in the throughputs between the analysis processing tasks which are executed in parallel at the time of using the entire data sets may be equalized.

Further, when a part of data sets is joined, the data size of each of the division area is equal to or smaller than the reference value and the differences in the throughputs between the analysis processing tasks are equalized.

When by redividing the division area, an overhead in controlling the tasks of the joining processing and the analysis processing occurs, if the allocated division area is reduced, plural division areas is allocated to the task to which the division area is allocated so that the throughput which is executed by one task may be increased.

Further, the above-mentioned predetermined reference value may be determined based on the allowable difference in throughputs of the tasks because the reference value affects the difference in the throughput of the tasks.

If the reference value is set to be too small, the number of division areas is increased so that the overhead of the data addition processing is increased. In contrast, if the reference value is set to be too large, the difference in the throughputs between the tasks is increased so that the efficiency of the parallel processing is lowered.

Therefore, a data amount in which an execution time when one task executes a predetermined amount of data is equal to or shorter than an allowable time as a difference in the execution times between the tasks is set as the predetermined reference value.

The data which is added in the data addition processing is input with a format as illustrated in FIG. 20. In the data addition processing, the data with a format as illustrated in FIG. 22A is converted into a format grouped by the user ID to be stored in the distributed file system. Hereinafter, the data set with the format of FIG. 20 is referred to as raw data and the data with the format of FIG. 21 is referred to as structured data.

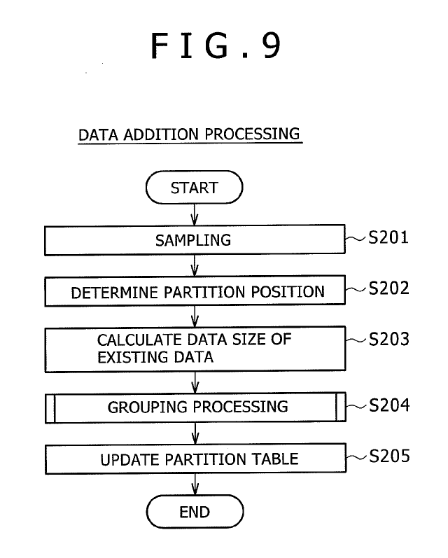

Hereinafter, the processings will be specifically described with reference to FIG. 9.

FIG. 9 is a flowchart explaining the data addition processing according to the first embodiment of the present invention.

When the user inputs the raw data to the distributed file system which is implemented by the file server (master) 23 and the file server (slave) 32, the data addition processing is performed.

First, the data management unit 21 samples the input raw data and analyzes an occurrence frequency of the key (step S201).

Specifically, the data management unit 21 randomly samples records included in the raw data. The data management unit 21 creates a list of keys having a first field of the read record as a key.

Further, in the raw data, one record is formed of data with one column format so that the data management unit 21 detects a line feed code to read out one record of data.

When the number of sampling is increased in order to improve the precision, the data management unit 21 performs the sampling processing in parallel. In this case, the data management unit 21 divides the raw data into plural data so as to make the data size equal and the sampling processing is performed for every divided raw data.

Specifically, the data management unit 21 allocates the executing tasks of the sampling processing into the slave nodes 30 and allocates the divided raw data into the executing tasks. The data management unit 21 receives the sampling processing result from the processing executing unit 31 of each of the slave nodes 30 and aggregates the sampling processing results received from all the slave nodes 30 to create a list of keys.

Next, the data management unit 21 determines a key value which becomes a division position of the raw data based on the created list of keys (step S202).

The division processing is a division processing to output raw data input in step S204 which will be described below, which is different from the division processing in the division table T200.

However, in the processing of step S204, the existing division position is not changed. Therefore, the division position of the raw data needs to match with the division position of the division table T200 of the existing data set.

Specifically, the following processings will be performed.

The data management unit 21 creates the key size table T400 including the division positions of the entire existing data sets with reference to the division table T200. For example, the key size table T400 as illustrated in FIG. 7A is created. However, at this time, no value is stored in the size T402.

The data management unit 21 specifies a corresponding division area for every sampled key and increments a data size of the data corresponding to the key to the size T402 of the corresponding entry of the key size table T400.

By the above processings, the data management unit 21 obtains a distribution of sampled keys.

For example, if the sampled key is “125d”, since the key is over “034a” and below “172d”, to the size T402 of the entry whose key T401 is “172d”, the data size of the data whose key is “125d” is incremented.

After obtaining the distribution of the keys, the data management unit 21 merges adjacent division areas of the key size table T400 so as to match the parallel number designated by the user with the number of division areas. In this case, the data size of each of the merged division areas is preferably uniformized.

For example, if the parallel number designated by the user is “2”, the key size table T400 whose distribution of keys is as illustrated in FIG. 7B has four division areas so that the division areas need to be merged to be two division areas. Therefore, the data management unit 21 merges the entry whose key T401 is “034a” and the entry whose key T401 is “172d” as one division area and merges the entry whose key T401 is “328b” and an empty entry as one division area.

After completing the merge processing, the data management unit 21 stores the merged result in the key T301 of the partition table T300.

Further, in the merge processing described above, if the number of entries of the key size table T400 is equal to or larger than the parallel number designated by the user, the merge processing is not performed and the number of entries becomes the parallel number.

The processing in step S202 has been described above.

Next, the data management unit 21 calculates the data sizes of entire data sets which are likely to be joined in the analysis processing (step S203). Further, the data management unit 21 creates the key size table T400 based on the calculation result.

Specifically, the following processings will be performed.

The data management unit 21 obtains the division table name T102 of each of the data sets with reference to the data management table T100. Further, the data management unit 21 obtains a list of the corresponding division table T200 based on the obtained division table name T102.

Further, the division positions of the respective data sets to be joined in the division table T200 match with each other. Therefore, it is possible to combine the division areas in the analysis processing in parallel.

The data management unit 21 creates the key size table T400 including the key T203 of the obtained division table T200. Further, the data management unit 21 calculates the data size of each of the division areas for every division table T200 and adds the calculated data size to the size T402 of the created key size table T400.

The same processing is performed on all obtained division tables T200 so that the key size table T400 for all existing data sets which are present in the distributed file system may be created.

For example, the above-mentioned processing is performed on the division table T200 illustrated in FIGS. 5A and 5B so that the key size table T400 as illustrated in FIG. 7A is created.

The processing in step S203 has been described above.

Next, the data management unit 21 performs a grouping processing on the raw data based on the partition table T300 indicating the merge result in step S202 (step S204).

Here, the grouping processing is a processing that aggregates the records included in the raw data for every key (the user ID in the example illustrated in FIG. 20).

In the grouping processing, the data management unit 21, the data adding unit (Map) 33, and the data adding unit (Reduce) 34 cooperate to perform the processing.

The data adding unit (Map) 33 and the data adding unit (Reduce) 34 perform parallel processings, respectively, in accordance with the instruction from the data management unit 21.

Further, if the number of entries of the partition table T300 becomes the parallelism of the data adding unit (Reduce) 34 which allocates the tasks. In the meantime, the parallelism of the data adding unit (Map) 33 which allocates the tasks is irrelevant to the number of entries of the partition table T300 but is designated by the user.

Hereinafter, the data adding unit (Map) 33 is referred to as a Map task and the task which is allocated to the data adding unit (Reduce) 34 is referred to as a Reduce task.

Specifically, the following processings will be performed.

The data management unit 21 divides the raw data in accordance with the parallel number designated by the user so as to uniformize the data sizes. Further, the data management unit 21 calculates an offset position which is the division position of the division area created by dividing the raw data and the data size of the division area. In addition, the offset position is adjusted so as to be matched with the record boundary by scanning a part of the raw data.

The data management unit 21 creates the Map tasks as many as the parallel number designated by the user in cooperation with the processing management unit 22 and allocates the created Map tasks to the data adding units (Map) 33. In this case, the offset position of the division area, the data size of the division area, and a file name of the raw data are transmitted to each of the data adding units (Map) 33.

Further, the data management unit 21 creates the Reduce tasks as many as the number of entries of the partition table T300 in cooperation with the processing management unit 22.

Further, the data management unit 21 associates each of the entries of the partition table T300 with the data adding unit (Reduce) 34. The data management unit 21 allocates the Reduce task which processes the division area in the key range corresponding to the key T301 into each of the associated data adding units (Reduce) 34.

Further, the data management unit 21 transmits an entry corresponding to the transmitted key range in the key size table T400 created in step S202 to the data adding unit (Reduce) 34.

For example, the key range of the first entry of the partition table T300 illustrated in FIG. 6 is below “172d” so that the entries of the corresponding key size table T400 are the first and second entries of FIG. 7A. Therefore, the data management unit 21 transmits the first entry and the second entry to the corresponding data adding unit (Reduce) 34.

Further, the data management unit 21 obtains destination information (address: port number) of the data adding unit (Reduce) and stores the obtained destination information in the destination T302 of the corresponding entry of the partition table T300.

After creating the partition table T300, the processing management unit 22 transmits the completed partition table T300 to all data adding units (Map) 33.

The processing in step S204 has been described above.

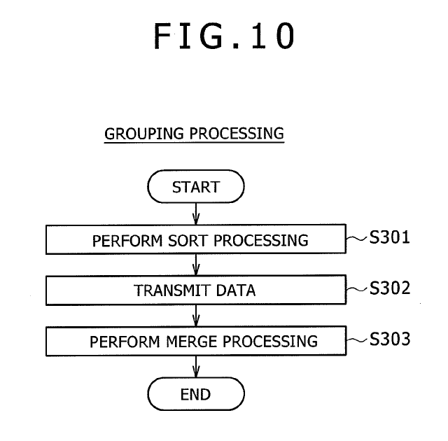

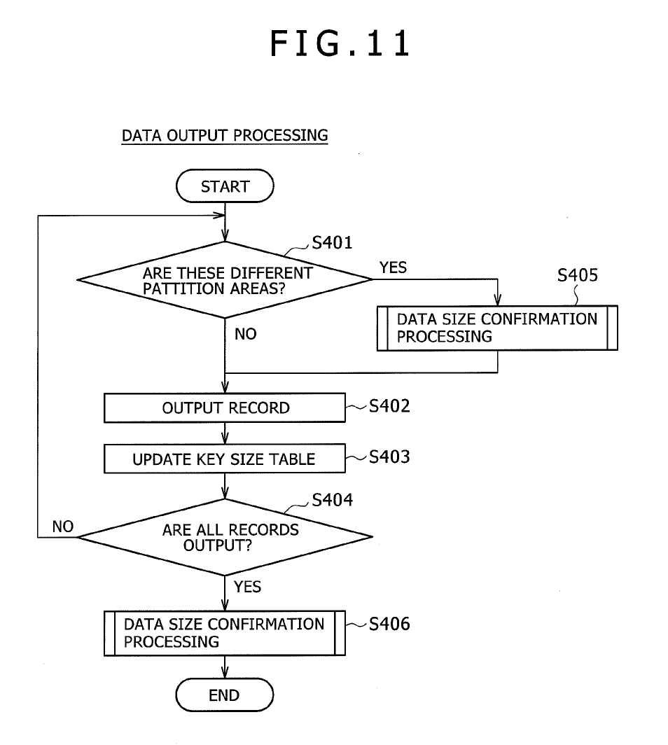

Further, the data adding unit (Map) 33 and the data adding unit (Reduce) 34 in step S204 perform a data output processing after performing the grouping processing. Details of the grouping processing will be described below with reference to FIG. 10 and details of the data output processing will be described below with reference to FIG. 11.

The data management unit 21 updates the division table T200 and ends the processing (step S205).

Specifically, the data management unit 21 updates the division table T200 which is managed by the data management unit 21 based on the division table T200 received from the data adding unit (Reduce) 34. Further, the received division table T200 is a table obtained after the data adding unit (Reduce) 34 performs a processing which will be described below (see FIGS. 10 and 11).

The data adding unit (Reduce) 34 processes only a part of the data sets in the key range. The embodiment is characterized in that all division tables T200 in the data analysis system are updated based on the division table T200 updated by one data adding unit (Reduce) 34.

Further, the data management unit 21 merges the division tables T200 of the input raw data which are received from the respective data adding units (Reduce) 34 to one table and manages the merged table as the division table T200 of the input raw data.

The above processing aggregates results of the processings because the processings on the raw data in the data adding units (Reduce) 34 are performed in parallel for every key range.

Further, the data management unit 21 adds the entry of the raw data corresponding to the division table T200 to the data management table T100.

Next, details of the grouping processing in step S204 will be described.

FIG. 10 is a flowchart explaining details of the grouping processing according to the first embodiment of the present invention.

The slave node 30 performs a sort processing on the input raw data (step S301).

Specifically, the following processings will be performed.

The data adding unit (Map) 33 reads out records one by one from the raw data. The data adding unit (Map) 33 obtains the destination information of the data adding unit (Reduce) 34 from the partition table T300 based on the key of the read record. In other words, the data adding unit (Reduce) 34 which processes the read record is specified.

The data adding unit (Map) 33 classifies the read records for every destination. Hereinafter, a record group which is classified for every destination is referred to as a segment.

The data adding unit (Map) 33 reads out all records included in the divided raw data which the data adding unit (Map) 33 undertakes and then sorts the records included in each of the segments based on the key.

The processing in step S301 has been described above.

Next, the slave node 30 transmits the sorted segment to the data adding unit (Reduce) 34 (step S302).

Specifically, the data adding unit (Map) 33 transmits the sorted segment to the data adding unit (Reduce) 34 corresponding to the destination information obtained in step S301. Each of the data adding units (Reduce) 34 receives the segment transmitted from the data adding unit (Map) 33 of each of the slave nodes 30.

The slave node 30 which receives the segment from the data adding unit (Map) 33 merges the received segments based on the key and ends the processing (step S303).

Specifically, the data adding unit (Reduce) 34 sequentially reads out all of the received segments and merges the segments having the same key to be joined.

Further, the data adding unit (Reduce) 34 converts the record included in the merged segment into structured data as illustrated in FIG. 10. By the above-mentioned processing, plural records are aggregated in one record having the same key.

Next, the data output processing which is performed by the data adding unit (Reduce) 34 in step S204 will be described.

FIG. 11 is a flowchart explaining the data output processing according to the first embodiment of the present invention.

First, the data output processing will be briefly described.

The data adding unit (Reduce) 34 performs the data output processing to output the structured data having the format as illustrated in FIG. 22A to the distributed file system. The tasks as many as the number of parallelism executed in the data adding unit (Reduce) 34. In this case, file names output by the data adding unit (Reduce) 34 are different from each other.

Further, in the present invention, the data adding unit (Reduce) 34 adds the data size of the raw data to the key size table T400 to calculate the data sizes of the division areas after adding the raw data.

If there is a division area whose data size is equal to or larger than a predetermined threshold value, the data adding unit (Reduce) 34 performs the division processing of the division area.

When the division processing of the division area is performed, the data adding unit (Reduce) 34 updates the division table T200 of the existing data set which is managed by the data adding unit (Reduce) 34. Further, the data adding unit (Reduce) 34 transmits the updated division table T200 to the data management unit 21. The data management unit 21 performs a processing (step S205) of updating the division table T200 based on the updated division table T200.

Further, the data adding unit (Reduce) 34 creates the division table T200 of the input raw data and transmits the created division table T200 to the data management unit 21 after completing the processing.

Hereinafter, details of the processings will be described.

First, before staring the data output processing, the data adding unit (Reduce) 34 creates a key size table T400 in which only keys included in the key size table T400 received from the data management unit 21 in step S204 are stored. Here, the created key size table T400 is a table in which a data size of a predetermined division area of the raw data is stored.

Hereinafter, the created key size table T400 is also referred to as an adding key size table T400. Further, at the time when the adding key size table T400 is created, an initial value of the size T402 is set to “0”.

Further, the key size table T400 received from the data management unit 21 is a table in which the data sizes of entire data sets on the distributed file system included in the key range which the data adding unit (Reduce) 34 undertakes are managed. Hereinafter, the corresponding key size table T400 is referred to as a key size table T400 for entire data.

If the data output processing starts, the data adding unit (Reduce) 34 outputs the records created in step S303 and determines whether the record is included in a division area which is different from that of a record which is previously output (step S401).

Specifically, the data adding unit (Reduce) 34 determines whether the output record is included in a division area different from that of the previously output record with reference to the key T402 of the adding key size table T400.

In the embodiment, since the records sorted based on the key are sequentially output, it is possible to determine whether the output record is included in a predetermined key range, that is, a predetermined division area.

Further, it is determined that records which are output first are included in the same division area.

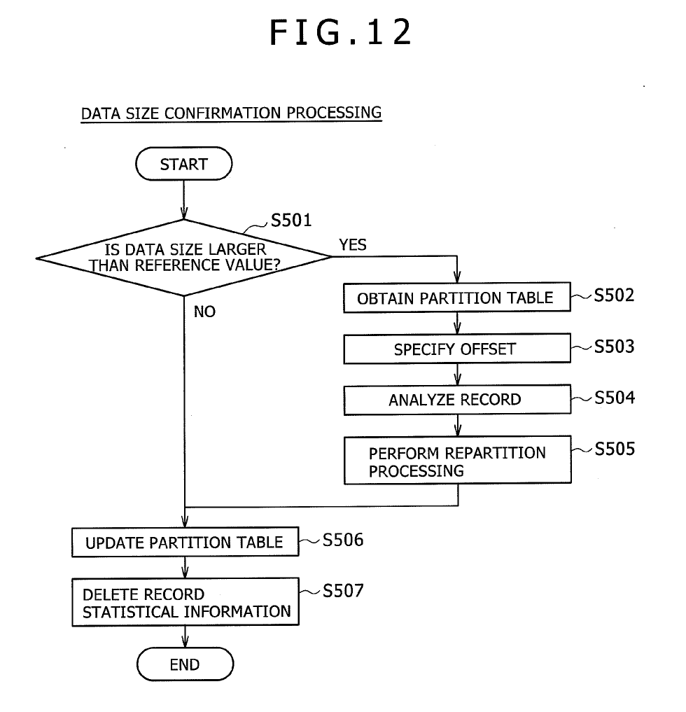

If it is determined that the records are included in the different division areas, the data adding unit (Reduce) 34 performs a processing of confirming the data size of the division area to which the previous record is added (step S405) and proceeds to step S402. Further, the data size confirmation processing will be described below with reference to FIG. 12.

If it is determined that the records are included in the same division area, the data adding unit (Reduce) 34 writes the record created in step S303 in the distributed file system (step S402).

In this case, the data adding unit (Reduce) 34 creates record statistical information including a key value of a written record, an offset position on a file in which the record is written, and a data size of the record and stores the created record statistical information. The record statistical information is record statistical information of the raw data.

Next, the data adding unit (Reduce) 34 updates the key size table T400 (step S403).

Specifically, the data adding unit (Reduce) 34 specifies the division area of the key range in which a key of the record written in step S402 is included. The data adding unit (Reduce) 34 searches an entry corresponding to the specified division area from the adding key size table T400 and the entire data key size table T400. Further, the data adding unit (Reduce) 34 adds the data size of the written record to the size T402 of the corresponding entry of each of the key size tables T400.

The data adding unit (Reduce) 34 determines whether all records are output (step S404).

If it is determined that all records are not output, the data adding unit (Reduce) 34 returns to step S401 to perform the same processing.

If it is determined that all records are output, the data adding unit (Reduce) 34 performs the data size confirmation processing for the last division area and ends the processing (step S406). Further, the data size confirmation processing in step S406 is the same processing as step S405.

FIG. 12 is a flowchart explaining the data size confirmation processing according to the first embodiment of the present invention.

The data adding unit (Reduce) 34 determines whether the data size of the division area which is a target is larger than a predetermined reference value with reference to the entire data key size table T400 updated in step S403 (step S501). In other words, it is determined whether the division area to which the raw data is added is larger than the predetermined reference value.

Here, the division area which is a target refers to a division area in which the previously input record is included. Hereinafter, the division area which is a target is also referred to as a target area.

Specifically, the data adding unit (Reduce) 34 determines whether the data size of the target area is larger than a predetermined reference value with reference to the size T402 of the corresponding entry of the entire data key size table T400.

If it is determined that the data size of the target area is equal to or smaller than the predetermined reference value, the data adding unit (Reduce) 34 proceeds to step S506.

If it is determined that the data size of the target area is larger than the predetermined reference value, the data adding unit (Reduce) 34 obtains a division table T200 of an existing data set from the master node 20 (step S502).

Here, all division tables T200 which are obtained by the master node 20 in step S203 are obtained. Further, the data adding unit (Reduce) 34 may store the division table T200 obtained from the master node 20 as a cache.

Next, the data adding unit (Reduce) 34 specifies an ending position of the target area in the obtained division table T200, that is, an offset (step S503).

Specifically, the following processings will be performed.

The data adding unit (Reduce) 34 obtains an entry corresponding to the target area based on the key of the target area, with reference to the obtained division tables T. That is, the data file name T202 and the offset T204 of the data corresponding to the target area are obtained. Further, the processing is performed on all division tables T200 obtained in step S502.

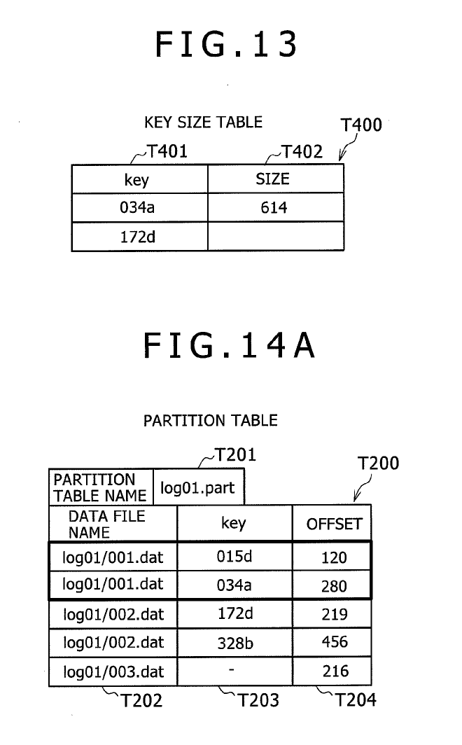

For example, in step S501, if the key size table is the entire data key size table T400 as illustrated in FIG. 13 and the data size of the division area corresponding to the first entry is larger than a predetermined reference value, the data adding unit (Reduce) 34 obtains information from the first entry of the division table T200 illustrated in FIGS. 5A and 5B.

In this case, in FIG. 5A, (data file name, offset)=(/log 01/001.dat, 280) and in FIG. 5B, (data file name, offset)=(/log 02/002.dat, 200). The obtained offsets become ending positions of the target areas in the respective division tables T200.

Further, since the starting position of the target area is the first entry, the offset of the starting position is “0”.

Next, the data adding unit (Reduce) 34 analyzes the record included in the target area of each of the existing data sets (step S504).

Specifically, the data adding unit (Reduce) 34 reads out the record included in the target area of each of the existing data sets. For example, if there is a data set whose data ID T101 is“log 01” and “log 02”, a record is read out from the target area of the data set of “log 01” and a record is also read out from the target area of the data set of “log 02”.

The data adding unit (Reduce) 34 obtains record statistical information including a key of the read record, a data size of the record, and an offset position of the record on the file.

Further, there are plural existing data sets, so that the analysis processing of the record may be performed in parallel for every data set.

The data adding unit (Reduce) 34 combines the record statistical information of the raw data obtained in step S402 and the record statistical information of the existing data set to consider the joined information as record statistical information of entire data sets in the distributed file system.

Next, the data adding unit (Reduce) 34 determines a key value which becomes a division position to be redivided, based on the record statistical information of the entire created data sets (step S505).

Specifically, the following processings will be performed.

The data adding unit (Reduce) 34 calculates the data size in the target area based on the record statistical information of the entire data sets.

The data adding unit (Reduce) 34 calculates a division number in the target area based on the calculated data size and a predetermined reference value.

Next, the data adding unit (Reduce) 34 divides the data size of the target area by the calculated division number to calculate the data size of the division area after being redivided.

The data adding unit (Reduce) 34 sorts the entries of the record statistical information of the entire data sets by the key and then calculates a cumulative value distribution of the data size of the record. In other words, a distribution of the data sizes of the records included in a predetermined key range in the distributed file system is calculated.

The data adding unit (Reduce) 34 determines a point where the data size of the record is equal to an integral multiple of the data size of the division area after being divided as the division position to be redivided based the calculated cumulative value distribution. If the data size of the record is not equal to an integral multiple of the data size of the division area, a record which is closest to the corresponding data size is determined as the division position.

As a key of a redivision position, a key which exists as data may be used or a key which does not exist as data may be used.

The data adding unit (Reduce) 34 specifies the offset corresponding to the determined key range with reference to the record statistical information of the entire data sets.

The data adding unit (Reduce) 34 adds the entry corresponding to the division area after being redivided to each of the division tables T200. Further, the data adding unit (Reduce) 34 deletes an entry corresponding to the division area before being redivided from each of the division tables T200.

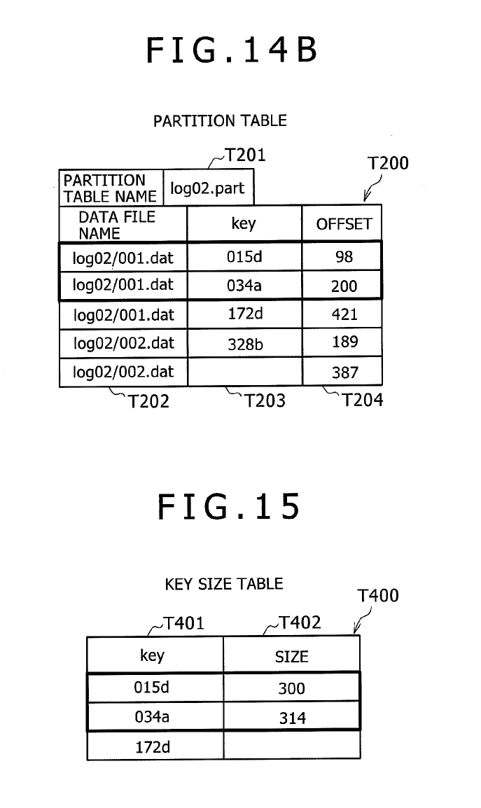

For example, if a division area whose key range is below “034a” is divided into two division areas, that is, a division area whose key area is below “015d” and a division area whose key area is over “015d” and below “034a”, the division tables T200 illustrated in FIGS. 5A and 5B are changed as illustrated in FIGS. 14A and 14B. In the drawings, a portion represented by a heavy line is a changed point.

The data adding unit (Reduce) 34 changes the adding key size table T400 and the entire data key size table T400 based on the record statistical information.

For example, if the entire data key size table T400 before being redivided is the table illustrated in FIG. 13, the table is changed as illustrated in FIG. 15. In the drawings, a portion represented by a heavy line is a changed point.

The processing of step S505 has been described above.

Next, the data adding unit (Reduce) 34 updates the division table T200 (step S506).

Specifically, the data adding unit (Reduce) 34 stores the entry of the division area corresponding to the division table T200 of the raw data, based on the adding key size table and the record statistical information of the raw data. That is, the division table T200 of the raw data is created.

Further, when the redivision processing is performed, an entry corresponding to a newly divided division area is stored.

The data adding unit (Reduce) 34 deletes the record statistical information which is used for the above-mentioned processing and ends the processing (step S507).

### Second Embodiment

In the first embodiment, contents of the file are stored in one file so that data which is unnecessary for the analysis processing is likely to be read out. In contrast, in a second embodiment, a method that stores the contents of the file as different files for every data item (row) is used. By using the corresponding method, it is possible to read out an item only necessary for the analysis processing.

The present invention may cope with a storing method that stores every data item in different files (row division storing method).

Hereinafter, the second embodiment will be described while focusing on a difference from the first embodiment.

In the second embodiment, the configuration of the data analysis system is the same as the first embodiment, so that the description thereof will be omitted. Further, the hardware configuration and the software configuration of the master node 20 and the slave node 30 are the same as the first embodiment, so that the description thereof will be omitted.

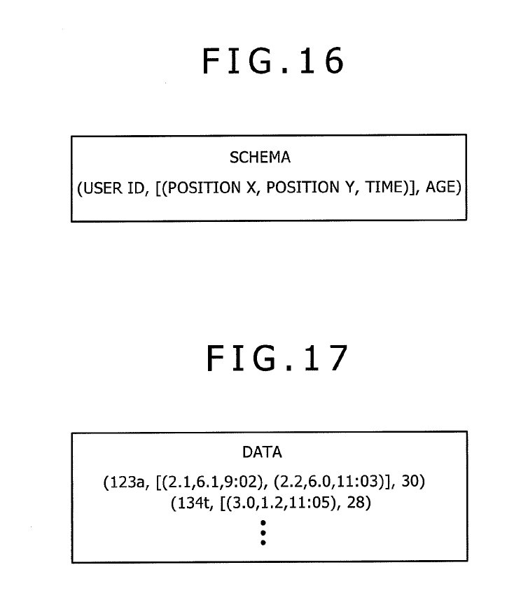

FIG. 16 is an explanatory diagram illustrating a schema of a record in the second embodiment of the present invention. FIG. 17 is an explanatory diagram illustrating an example of the record in the second embodiment of the present invention.

As compared with the record of the first embodiment, an age of the user is newly included in a record of the second embodiment.

The items of the record includes three types, that is, a user ID, a movement history (position X, position Y, history of time stamp), and an age and the user ID is used as a key in the embodiment.

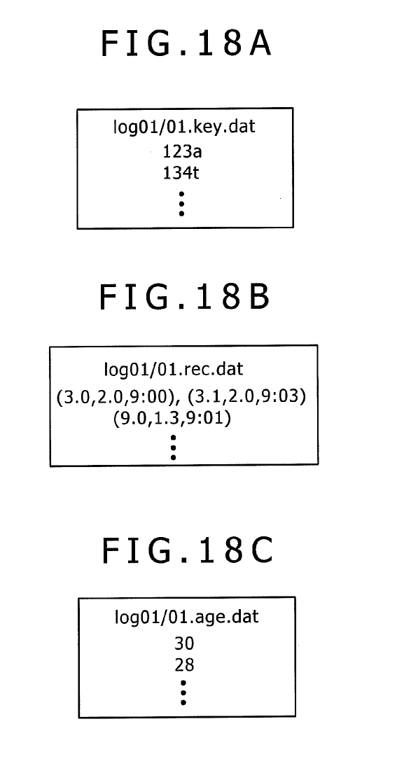

FIGS. 18A, 18B, and 18C are explanatory diagrams illustrating a file in the second embodiment of the present invention.

FIGS. 18A, 18B, and 18C illustrate an example where the above-mentioned data is stored in the file using a row dividing method.

As illustrated in FIGS. 18A, 18B, and 18C, the user ID is stored in a file of log/001.key.dat (see FIG. 18A), the movement history is stored in a file of log/001.rec.dat (see FIG. 18B), and the age is stored in a file of log/001.age.dat (see FIG. 18C).

When the data is read out, the records are sequentially read out one by one from the top of the file and if the records are sequentially joined, the entire records illustrated in FIG. 17 may be reconstructed.

In the example illustrated in FIGS. 18A, 18B, and 18C, there are only one set of files. However, as the data is periodically accumulated, the data sets including files corresponding to the user ID, the movement history, and the age are increased.

The actual joining processing and the analysis processing are performed in parallel so that the processing is performed by each of the slave nodes 30 after dividing the above-mentioned file.

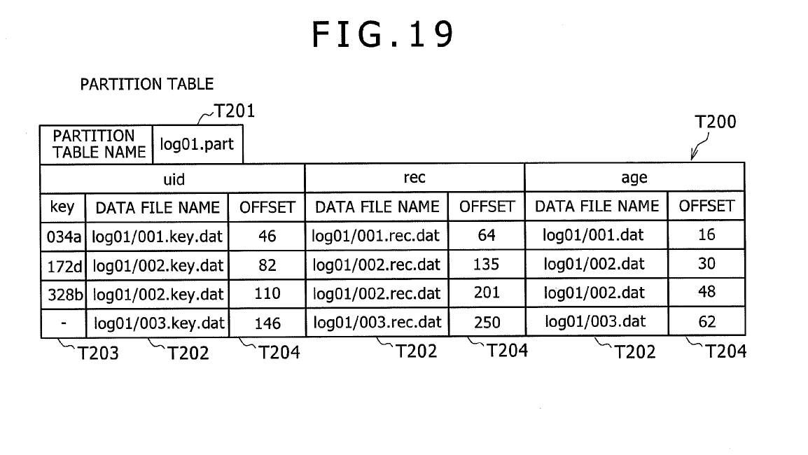

FIG. 19 is an explanatory view illustrating an example of a division table T200 in the second embodiment of the present invention.

The division table T200 of the second embodiment stores the data file name T202 and the offset T204 in every item (user ID, movement history, and age), which is different from the first embodiment. Further, a key value representing the division position is stored in the key T203 for an item used as a key.

Next, the joining processing and the analysis processing in the second embodiment will be described while focusing on the difference from the first embodiment.

In step S101, when the key size table T400 is created, the data management unit 21 calculates a size of each of the division areas with reference to the offset of an item of the division table T200 which will be used for the analysis processing.

For example, if analysis which uses only the user ID and the age is performed, a size of the key size table is calculated only using an offset of “uid” and an offset of “age”. In this case, an offset for “rec” is not used.

BY doing this, even when only some items are used, the data size of each of the division areas is accurately calculated.

Further, in step S104, each of the slave nodes 30 to which the task is allocated reads out files as many as a number obtained by multiplying the number of files which are used for the analysis processing and the number of items which are used for the analysis processing.

The data addition processing is also different from the first embodiment as follows.

In step S203, the data management unit 21 creates the key size table T400 of the existing data set from an offset for every item of the division table T200 of all data sets which are likely to be joined.

In step S402, when the records are output in files, the records are output in a separate file for every item. Therefore, in step S402, record statistical information including a key value of written record, an offset on a written file, and a data size is stored for every item.

Further, in step S403, the sum of the sizes of the division areas of the entire items is added to the corresponding entry of the key size table T400.

In step S506, the offset value of the division position for every item is calculated using the record statistical information and the key size table T400 described above to update the division table T200.

In step S504, a file corresponding to the entire items which are included in the data is read out and the record statistical information including the key value of the written record, the offset position on the written file, and the data size is stored in the file for every item.

In step S505, the data adding unit (Reduce) 34 determines a key of the division position using the summation of the data sizes of the division areas of the entire items as a data size of the corresponding data set.

In step S506, the data adding unit (Reduce) 34 uses the determined key and the record statistical information to calculate the offset of the division position for every item and update the division table T200.

Even though in the second embodiment, it is described that three items are processed, but the number of items may be arbitrarily set by changing the number of items managed in the division table T200.

According to an aspect of the present invention, in the data analysis system, the division positions of the data sets are the same so that the joining processing in the analysis processing may be performed in parallel. Further, if a data set is newly added, the division area may be redivided to uniformize the throughputs between tasks. By doing this, it is possible to remove the unbalance in the processing between the tasks and combine the records for every division area at the time of joining processing.

While the present invention has been described in detail with reference to the accompanying drawings, the invention is not limited to the specific configuration but various changes and equivalent configuration may be included within the spirit of the attached claims.

What is claimed is:

1. A computer system in which a plurality of computers perform an analysis processing of a data set including a plurality of data configured with a key and a data value, in parallel,
wherein each of the computers includes a processor, a memory connected to the processor, a storage device connected to the processor, and a network interface connected to the processor,
each of the computers retains division information which manages a division position key which is a key indicating a division position of a division area obtained by dividing the data set for every predetermined key range, for every data set,
all division position keys included in the division information of each of the data set are same,
a file system that stores the data set is configured on a storage area of each of the plurality of computers, and
the computer system, when the analysis processing is performed, creates a plurality of tasks for every division area,
allocates the created task into each of the computers to combine the data included in the division areas of each of the data sets to perform the analysis processing,
when a new data set is stored in the file system, determines whether there is a target area which is the division area having a data size larger than a predetermined threshold value, based on a data size of each of the division areas after storing the new data set, and
if it is determined that there is the target area, divides the target area into a plurality of new division areas.

2. The computer system according to claim 1, wherein when a new data set is stored in the file system, a key distribution of the new data set is analyzed, and
based on the analysis result, the division information of the new data set is created so as to be equal to all division position keys included in the division information of an existing data set.

3. The computer system according to claim 2, wherein after dividing the target area, the division position key in the division information of the existing data set is updated.

4. The computer system according to claim 3, wherein if it is determined whether the target area is present, the data sizes of the division areas of all of the data sets are added to calculate a first data size which is a data size of the division area in the computer system,
it is determined whether the division area whose calculated first data size is larger than the predetermined threshold value is present,
when the target area is divided, the data sizes of the target areas of all of the data sets are added to calculate a second data size which is a data size of the target area in the computer system,
a division number of the target area is calculated based on the predetermined threshold value and the calculated second data size,
a new division position key in the target area is determined based on the calculated division number,
when the division position key of division information of the existing data set is updated, information corresponding to the target area is deleted from the division information of the existing data set and information in which the determined division position key is associated with the new division area is added, and
when the division information of the new data set is created, the division information of the new data set is created so as to be equal to the division key in the division information of the updated existing data set.

5. The computer system according to claim 4, wherein when the target area is divided, the data size of the target area is divided by the calculated division number to calculate a third data size, and
the key in the data corresponding to the calculated third data size is determined as the division position key.

6. The computer system according to claim 4, wherein the predetermined threshold value is a data size when a processing time of a task to which the new division area is allocated is equal to or shorter than a predetermined allowable time.

7. The computer system according to claim 4, wherein the data includes a data value for every item, and
when the first data size is calculated, the data sizes of all items in the division area are added to calculate the first data size.

8. The computer system according to claim 2, wherein when a key distribution of the new data sets is analyzed, the new data set is divided by a division position key which matches with any one of the division position keys included in the division information of the existing data set to create a plurality of processing division areas, and
a task which analyzes the key distribution of the new data set is created for every created processing division area to execute tasks in parallel.

9. A data management method in a computer system in which a plurality of computers perform an analysis processing of a data set including a plurality of data configured by a key and a data value, in parallel,
wherein each of the computers includes a processor, a memory connected to the processor, a storage device connected to the processor, and a network interface connected to the processor,
each of the computers retains division information which manages a division position key which is a key indicating a division position of a division area obtained by dividing the data set for every predetermined key range, for every data set,
all division position keys included in the division information of each of the data sets are same,
a file system that stores the data set is configured on a storage area of each of the plurality of computers, and
the method comprises:
a first step of creating a plurality of tasks for every division area when at least one of the computers performs the analysis processing;
a second step in which the computer which creates the task allocates the created task to each of the computers and combines the data included in the division areas of each of the data sets to perform the analysis processing;
a third step in which when a new data set is stored in the file system, at least one of the computers determines whether there is a target area which is the division area having a data size larger than a predetermined threshold value, based on a data size of each of the division areas after storing the new data set, and
a fourth step in which if it is determined that the target area is present, the computer which performs the determination processing divides the target area into a plurality of new division areas.

10. The data management method according to claim 9, wherein the third step includes:
a fifth step of analyzing a key distribution of the new data sets; and
a sixth step of creating the division information of the new data set, based on the analysis result, so as to be equal to all of the division position keys included in the division information of the existing data set.

11. The data management method according to claim 10, wherein the fourth step includes a seventh step of updating the division position key in the division information of the existing data set after dividing the target area.

12. The data management method according to claim 11, wherein the third step includes:
an eighth step of adding data sizes of the division areas of all of the data sets to calculate a first data size which is a data size of the division area in the computer system; and
a ninth step of determining whether the division area whose calculated first data size is larger than the predetermined threshold value is present,
the fourth step includes:
a tenth step of adding data sizes of the target areas of all of the data sets to calculate a second data size which is a data size of the target area in the computer system; and
an eleventh step of calculating a division number of the target area based on the predetermined threshold value and the calculated second data size; and
a twelfth step of determining a new division position key in the target area based on the calculated division number,
the seventh step includes:
a thirteenth step of deleting information corresponding to the target area from the division information of the existing data set and adding information in which the determined division position key is associated with the new division area, and
the sixth step includes:
a fourteenth step of creating division information of the new data set so as to be equal to the division key in the updated division information of the existing data set.

13. The data management method according to claim 12, wherein the twelfth step includes:
a step of dividing the data size of the target area by the calculated division number to calculate a third data size; and
a step of determining the key in the data corresponding to the calculated third data size as the division position key.

14. The data management method according to claim 12, wherein the predetermined threshold value is a data size when a processing time of a task to which the new division area is allocated is equal to or shorter than a predetermined allowable time.

15. The data management method according to claim 12, wherein the data includes a data value for every item, and
in the eighth step, the data sizes of all items in the division area are added to calculate the first data size.

16. The data management method according to claim 10, wherein the fifth step includes:
a step of dividing the new data set by a division position key which matches with any one of the division position keys included in the division information of the existing data set to create a plurality of processing division areas; and
a step of creating a task which analyzes a key distribution of the new data set for every created processing division area to perform the tasks in parallel on each of the computers.
